(19) United States
(12) Patent Application Publication
(10) Pub. No.: US 2024/0068294 A1
(43) Pub. Date: Feb. 29, 2024

(54) Magnetic Window Attachments

(71) Applicant: Cortex, LLC, Knoxville, TN (US)

(72) Inventors: Rodney Napier, Knoxville, TN (US); Zachary P. Beard, Jefferson City, TN (US)

(73) Assignee: Cortex, LLC, Knoxville, TN (US)

(21) Appl. No.: 18/458,182

(22) Filed: Aug. 30, 2023

Related U.S. Application Data
(60) Provisional application No. 63/402,564, filed on Aug. 31, 2022.

(51) Int. Cl. E06B 3/667; E06B 3/68

(52) U.S. Cl. CPC E06B 3/6675; E06B 3/685

(57) ABSTRACT

A magnetic window attachment assembly for attaching a muntin grid to a windowpane includes a first magnet or first ferromagnetic material attached to the windowpane at a first location and a second magnet or second ferromagnetic material attached to the muntin grid at a second location that aligns with the first location when the muntin grid is installed thereon. Magnetic attraction between the first magnet or the first ferromagnetic material and the second magnet or the second ferromagnetic material causes the muntin grid to be attracted to and removably engaged with the windowpane. The first magnet or first ferromagnetic material may have a convex surface, and the second magnet or second ferromagnetic material may have a concave surface that mates with the convex surface of the first magnet or first ferromagnetic material.

### FIELD

The present disclosure relates to magnetic window attachments. More particularly, this disclosure relates to magnetic and/or ferromagnetic materials that are affixed to or embedded within windows and/or existing window components, including existing panes, muntins and grilles, sashes, rails, and casings.

### BACKGROUND

Divided-light windows are coveted for their historic and unique aesthetic. Such windows typically meet modern energy efficiency and performance standards and are often used in many homes and buildings. Two primary subcategories of divided-light windows exist: true divided-light (TDL) windows and simulated divided-light (SDL) windows.

TDL windows, which have existed since the very beginning of the glass production industry, consist of small panes of glass separated by muntins or grilles. In contrast, SDL windows consist of a single large piece of glass with removable muntins or grilles that provide the aesthetic of TDL windows, but with the easy installation and simplified maintenance of a single large pane. Current SDL window technologies implement mechanical structures or adhesives to either permanently or removably affix window muntins to the large pane of glass. These technologies typically do not provide an authentic TDL aesthetic, are not easily removed and reattached, are not easily customizable, and are difficult to clean.

### SUMMARY

The aforementioned problems and more are solved by the magnetic window attachments described herein. The attachments provide the pleasing aesthetic of TDL windows but are functionally simple and easily cleaned. The attachments are designed to work with most windows available on the market today, including window configurations with only single panes of glass as well as those with insulated glass window designs that involve multiple panes with air gaps between them. Some of the attachments described herein provide a more authentic simulation of a TDL window by means of a sandwiched internal muntin, providing a significant advantage over other products on the market today that allow a visibly apparent thermal gap, which denies an authentic TDL aesthetic.

The magnetic window attachments described herein involve magnetic and/or ferromagnetic materials that are affixed to or embedded within windows and/or existing window components, including existing panes, muntins, grilles, sashes, rails, casings, and more. The magnetic window attachments described herein are also designed to be highly customizable to fit each consumer's particular needs and circumstances and are adjustable based not only on the layout of the window, but also on the consumer's desired positioning and design.

Some embodiments described herein are directed to a magnetic window attachment assembly for attaching a muntin grid to a windowpane. The assembly includes a first attachment member that is attachable to the windowpane and a second attachment member that is attachable to the muntin grid. The first attachment member includes a first housing having opposing first and second surfaces. The first surface is configured for attachment to the windowpane. The second surface has a curved shape defined by a first radius of curvature. A first magnet or first ferromagnetic material is disposed within the first housing adjacent to its second surface. The second attachment member includes a second housing having opposing third and fourth surfaces. The third surface has a curved shape defined by a second radius of curvature that substantially matches the first radius of curvature. The fourth surface is configured for attachment to the muntin grid. A second magnet or second ferromagnetic material is disposed within the second housing adjacent to the third surface. Magnetic attraction between the first magnet or the first ferromagnetic material and the second magnet or the second ferromagnetic material causes the first housing of the first attachment member to be attracted to and removably engage the second housing of the second attachment member.

In some embodiments, the second surface of the first housing has a convex shape, and the third surface of the second housing has a concave shape.

In some embodiments, the first and second housings are formed from a thermoplastic material.

In some embodiments, the magnetic window attachment assembly includes an adhesive that attaches the first surface of the first housing to the windowpane.

In some embodiments, the magnetic window attachment assembly includes an adhesive that attaches the fourth surface of the second housing to the muntin grid.

In some embodiments, the second housing is integrated into the muntin grid, and the fourth surface is a surface of the muntin grid.

Some embodiments described herein are directed to a magnetic window attachment assembly for attaching a muntin grid to a windowpane. The assembly comprises a first magnet or first ferromagnetic material attached to the windowpane at a first location and a second magnet or second ferromagnetic material attached to the muntin grid at a second location that aligns with the first location of the windowpane when the muntin grid is installed thereon. Magnetic attraction between the first magnet or the first ferromagnetic material and the second magnet or the second ferromagnetic material causes the muntin grid to be attracted to and removably engaged with the windowpane.

In some embodiments, the magnetic window attachment assembly includes a plurality of first magnets or first ferromagnetic materials attached to the windowpane at several first locations, and a plurality of second magnets or second ferromagnetic materials attached to the muntin grid at several second locations that align with the first locations.

In some embodiments, the first magnet or first ferromagnetic material has a convex surface, and the second magnet or second ferromagnetic material has a concave surface that mates with the convex surface of the first magnet or first ferromagnetic material.

Some embodiments described herein are directed to a magnetic window attachment assembly for attaching a muntin grid to a window having a sash and a windowpane. The assembly includes a first magnet or first ferromagnetic material attached to the sash at a first location adjacent to the windowpane, and a second magnet or second ferromagnetic material attached to the muntin grid at a second location that aligns with the first location of the sash when the muntin grid is installed on the windowpane. Magnetic attraction between the first magnet or the first ferromagnetic material and the second magnet or the second ferromagnetic material causes the muntin grid to be attracted to and removably engaged with the sash.

In some embodiments, the magnetic window attachment assembly includes a plurality of first magnets or first ferromagnetic materials attached to the window sash at several first locations, and a plurality of second magnets or second ferromagnetic materials attached to the muntin grid at several second locations that align with the first locations.

Some embodiments described herein are directed to a magnetic window attachment assembly for attaching a muntin grid to a multi-pane window. The assembly includes a first magnet or first ferromagnetic material disposed between two windowpanes of the multi-pane window at a first location, and a second magnet or second ferromagnetic material attached to the muntin grid at a second location. The second location of the muntin grid aligns with the first location of the multi-pane window when the muntin grid is installed on the multi-pane window. Magnetic attraction between the first magnet or the first ferromagnetic material and the second magnet or the second ferromagnetic material causes the muntin grid to be attracted to and removably engaged with the multi-pane window.

In some embodiments, the magnetic window attachment assembly includes a plurality of first magnets or first ferromagnetic materials disposed between the two windowpanes at several first locations, and a plurality of second magnets or second ferromagnetic materials attached to the muntin grid at several second locations that align with the first locations.

### BRIEF DESCRIPTION OF THE DRAWINGS

Further advantages of the invention are apparent by reference to the detailed description in conjunction with the figures, wherein elements are not to scale so as to more clearly show the details, and wherein:

FIGS. 1A, 1B, 1C and 1D depict a magnetic window attachment involving a magnetic structure having a convex attachment surface for attaching a window muntin grid to a window according to an embodiment of the invention;

FIGS. 2A, 2B, 2C and 2D depict a magnetic window attachment involving a magnetic structure having a concave attachment surface for attaching a window muntin grid to a window according to an embodiment of the invention;

FIG. 3 depicts magnetic window attachments involving magnetic structures having concave and convex attachment surfaces for attaching a window muntin grid to a window according to an embodiment of the invention;

FIGS. 4A and 4B depict magnetic or ferromagnetic materials disposed between panes of glass in a double-pane window for attaching magnetic and/or ferromagnetic muntin grid attachment structures to the window according to an embodiment of the invention; and

FIGS. 5A and 5B depict a removable muntin grid including magnetic or ferromagnetic fasteners inserted between a window sash and windowpane according to an embodiment of the invention.

### DETAILED DESCRIPTION

Embodiments described herein are directed to a set of magnetic window attachments that create SDL windows. Preferred embodiments include magnetic window attachments that incorporate a male/female connector design that reduces obstructions for window cleaning and decreases the possibility that the magnets or ferromagnetic materials affixed to the windows will be dislodged by cleaning or other forces. The complementary male/female structures also allow connected attachments to lie nearly flush against the pane of glass. The male and female connector design may be painted and may be affixed at any point within the area of the window inside or out, not limited to the perimeter. Multiple attachment points across the area of the window decrease sagging and warping of attachments, and ensures proper, tight adherence between the attachment structures and the pane of glass.

As the term is used herein, a ferromagnetic structure is a structure that contains or consists of a ferrous material or other material that is attracted to a magnet by magnetic force. As will be appreciated by one of ordinary skill in the art, a ferromagnetic material is a material having the same kind of magnetism as iron, such as a material having high magnetic permeability and appreciable residual magnetism and hysteresis, or possessing magnetization in the absence of an external magnetic field.

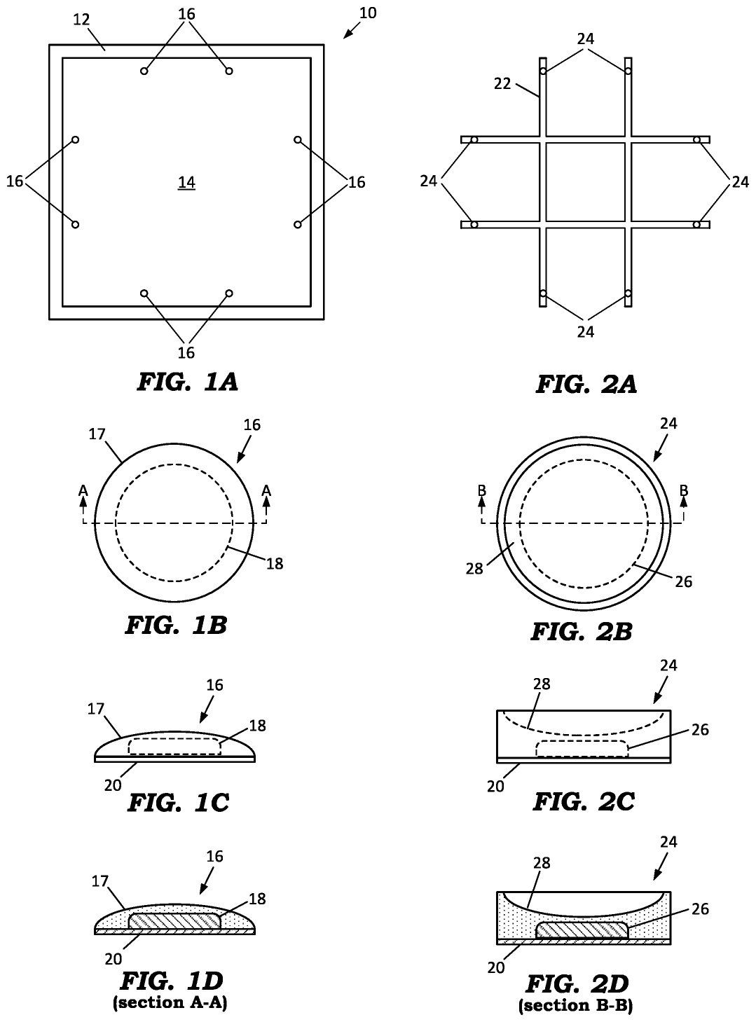

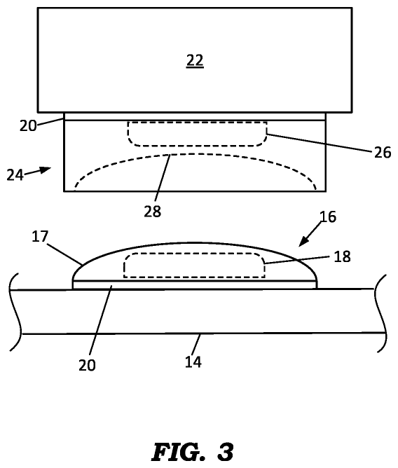

Magnetic window attachments according to a first embodiment are depicted in FIGS. 1A-1D, 2A-2D and 3. In this embodiment, a male/female connector design takes the form of concave/convex shaped housings 16 and 24 that hold magnets and/or ferromagnetic materials 18 and 26 affixed to the surface of a glass windowpane 14 of a window 10. A concave/convex configuration is preferable because it: (1) allows easy passage of cleaning products and tools over the exposed surfaces of the housings 16 on the windowpane 14, (2) allows attachments in the form of muntin grids 22 to lie nearly flush against the windowpane 14, and (3) ensures a high degree of alignment and a level, plumb finish when fitting a muntin grid 22 to the windows 10. The concave/convex housings 16 and 24 may be affixed to the windowpane 14 and muntin grid 22 either by adhesives 20 or by magnetic forces.

As shown in FIG. 1A, the housings 16 are attached to the windowpane 14 at locations corresponding to locations of mating housings 24 on the muntin grid 22. Although FIG. 1A depicts the housings 16 attached near the window sash 12, they could be attached at any location on the windowpane 14, as long as they are in alignment with the corresponding housings 24 on the muntin grid 22. The housings 16 may be attached to the windowpane 14 using an adhesive layer 20, such as a double-sided peel-and-stick adhesive. Alternatively, the housings 16 may be attached by magnetic force provided by a corresponding magnet attached to the opposite side of the windowpane 14.

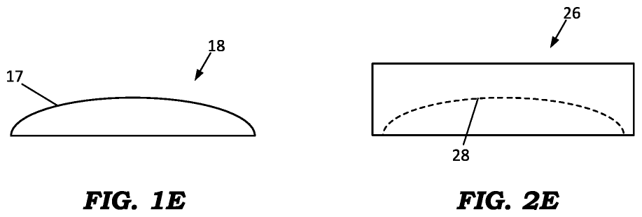

As shown in FIG. 2A, the housings 24 are attached to the muntin grid 22 at locations corresponding to the locations of the housings 16 on the windowpane 14. Although FIG. 2A depicts the housings 24 attached near the outer edges of the muntin grid 22, they could be attached at any location on the muntin grid 22, as long as they are in alignment with the corresponding housings 16 on the windowpane 14. The housings 24 may be attached to the muntin grid 22 using an adhesive layer 20, such as a double-sided peel-and-stick adhesive. Alternatively, the housings 24 may be attached by insertion into recesses in the surface of the muntin grid 22, or the housings 24 may be integrated into the muntin grid 22.

As shown in FIGS. 1C, 2C and 3, the housings 16 preferably have a convex attachment surface 17 with a semielliptical profile. Correspondingly, the housings 24 preferably have a concave attachment surface 28 with a semielliptical profile matching that of the convex surface 17. Semielliptical profiles are merely one example of convex profiles, and it will be appreciated that other low-profile convex shapes could be used for the housings 16, and complementary shapes for the housings 24.

In some embodiments, the housings 16 and 24 are molded plastic parts, and the magnets 18 and 26 are standard flat magnetic and/or ferromagnetic inserts. The magnets 18 and 26 may be embedded within the molded housings 16 and 24 via an over-molding process, or by insertion into recesses in previously molded plastic parts, or by other means. This embodiment provides all of the benefits of uniquely molded concave and convex magnetic and/or ferromagnetic materials along with decreased material and manufacturing costs.

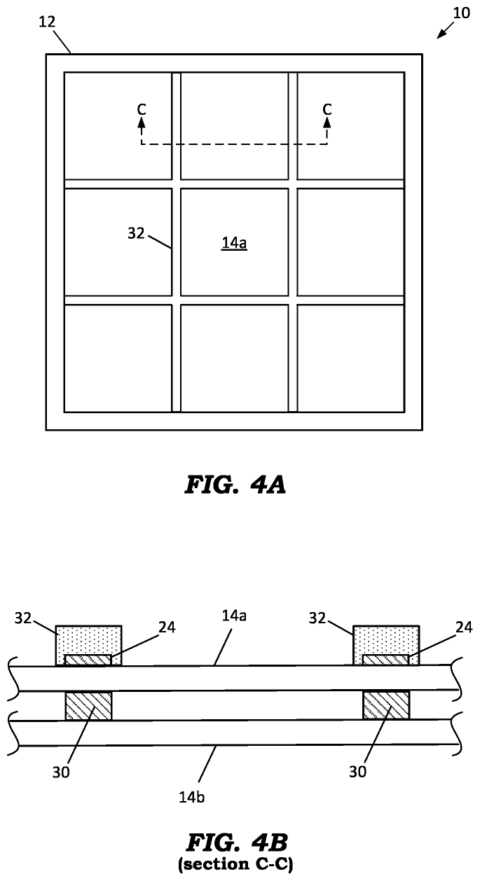

In a second embodiment depicted in FIGS. 4A and 4B, the magnetic window attachments are configured to incorporate magnetic or a ferromagnetic muntin-connecting members 30 sandwiched between multiple panes of glass 14a and 14b, such as in insulated glass windows. Multiple magnetic or ferromagnetic muntin-connecting members 30 may be used for insulated glass windows featuring multiple air gaps (e.g., an insulated glass window with three panes and two air gaps). This embodiment allows magnetic and/or ferromagnetic muntin grid attachments 32 to be attached to both the inside and outside of the window 10 without the need for adhesive. This arrangement dramatically increases the perception of TDL and provides effortless removal and reattachment of the muntin grid attachments 32 for maintenance. Although a double-pane window is depicted in the exemplary structure of FIGS. 4A and 4B, one of ordinary skill in the art will appreciate that the embodiments described herein are applicable to windows having any number of panes.

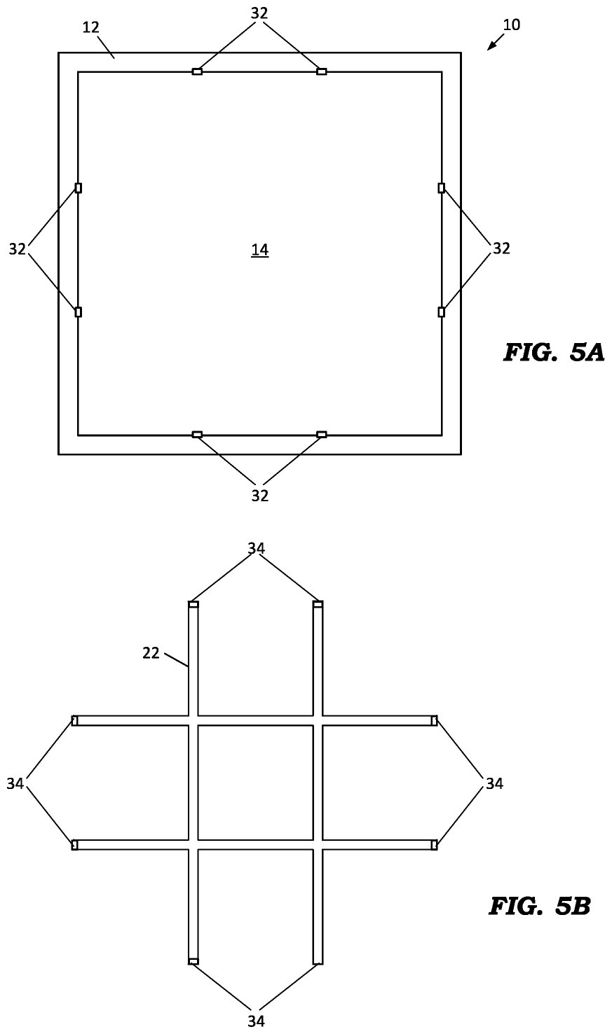

In the embodiment of FIGS. 5A and 5B, magnetic or ferromagnetic window grille fasteners 32 are inserted between the window sash 12 and windowpane 14. Corresponding magnets 34 are attached to the outer edges of the muntin grid 22. This configuration allows the removable window grid 22 to be easily installed and removed without the risk of damaging the window grid, which provides for ease of cleaning, renovation, or window repair.

The magnetic window attachments described herein may be used with muntins made from almost any material, including muntins that are painted or otherwise coated.

The foregoing description of preferred embodiments for this invention have been presented for purposes of illustration and description. They are not intended to be exhaustive or to limit the invention to the precise form disclosed. Obvious modifications or variations are possible in light of the above teachings. The embodiments are chosen and described in an effort to provide the best illustrations of the principles of the invention and its practical application, and to thereby enable one of ordinary skill in the art to utilize the invention in various embodiments and with various modifications as are suited to the particular use contemplated. All such modifications and variations are within the scope of the invention.

1. A magnetic window attachment assembly for attaching a muntin grid to a windowpane that is attached to a window sash, comprising:
a first attachment member that is separate from the window sash, the first attachment member comprising:
a first housing comprising:
a first surface configured for attachment to the windowpane; and
a second surface opposing the first surface, the second surface having a curved shape defined by a first radius of curvature; and
a first magnet or first ferromagnetic material disposed within the first housing adjacent to the second surface; and
a second attachment member comprising:
a second housing comprising:
a third surface having a curved shape defined by a second radius of curvature that substantially matches the first radius of curvature; and
a fourth surface opposing the third surface, the fourth surface configured for attachment to the muntin grid; and
a second magnet or second ferromagnetic material disposed within the second housing adjacent to the third surface,
wherein magnetic attraction between the first magnet or the first ferromagnetic material and the second magnet or the second ferromagnetic material causes the first housing of the first attachment member to be attracted to and removably engaged with the second housing of the second attachment member.

2. The magnetic window attachment assembly of claim 1 wherein the second surface of the first housing has a convex shape, and the third surface of the second housing has a concave shape.

3. The magnetic window attachment assembly of claim 1 wherein the first and second housings are formed from a thermoplastic material.

4. The magnetic window attachment assembly of claim 1 further comprising an adhesive that attaches the first surface of the first housing to the windowpane.

5. The magnetic window attachment assembly of claim 1 further comprising an adhesive that attaches the fourth surface of the second housing to the muntin grid.

6. The magnetic window attachment assembly of claim 1 wherein the second housing is integrated into the muntin grid, and the fourth surface is a surface of the muntin grid.

7. A magnetic window attachment assembly for attaching a muntin grid to a windowpane, comprising:
a first magnet or first ferromagnetic material attached to the windowpane at a first location using an adhesive layer disposed between the first magnet or first ferromagnetic material and the windowpane; and
a second magnet or second ferromagnetic material attached to the muntin grid at a second location that aligns with the first location of the windowpane when the muntin grid is installed on the windowpane,
wherein magnetic attraction between the first magnet or the first ferromagnetic material and the second magnet or the second ferromagnetic material causes the muntin grid to be attracted to and removably engaged with the windowpane.

8. The magnetic window attachment assembly of claim 7 further comprising a plurality of first magnets or first ferromagnetic materials attached to the windowpane at first locations, and a plurality of second magnets or second ferromagnetic materials attached to the muntin grid at second locations that align with the first locations.

9. The magnetic window attachment assembly of claim 7 wherein the first magnet or first ferromagnetic material has a circular convex surface, and the second magnet or second ferromagnetic material has a circular concave surface that mates with the circular convex surface of the first magnet or first ferromagnetic material.

10. (canceled)

11. (canceled)

12. (canceled)

13. (canceled)

14. The magnetic window attachment assembly of claim 1 wherein:
the second surface of the first housing covers the first magnet or first ferromagnetic material and is disposed between the first magnet or first ferromagnetic material and the third surface of the second housing when the first housing is removably engaged with the second housing, and
the third surface of the second housing covers the second magnet or second ferromagnetic material and is disposed between the second magnet or second ferromagnetic material and the second surface when the first housing is engaged with the second housing.
